(19) United States
(12) Patent Application Publication
(10) Pub. No.: US 2005/0209889 A1
(43) Pub. Date: Sep. 22, 2005

(54) Medical data storing method and terminal and server used for the same

(75) Inventor: Takeshi Funahashi, Kaisei-machi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/082,965

(22) Filed: Mar. 18, 2005

(30) Foreign Application Priority Data
Mar. 22, 2004 (JP) 2004-082875

(51) Int. Cl. G06F 17/60

(52) U.S. Cl. 705/3

(57) ABSTRACT

A medical data storing method by which management and retrieval can be performed easily without complicating the hierarchy structure of medical data when the medical data on medical images, examination results, or the like retained by plural medical facilities are centrally stored in a data center. This medical data storing method includes the steps of: creating, in the client terminal, third identification information by coupling patient identification information and medical facility identification information, which correspond to the medical data, in order to store the medical data obtained by imaging or examination for the purpose of diagnosis; transmitting the medical data with at least the third identification information from the client terminal to the database server; and recording, in the database server, the received medical data and at least the received third identification information in association with each other in a recording medium.

### BACKGROUND OF THE INVENTION

1. Field of the Invention

The present invention relates to a medical data storing method used in a medical data storage system for centrally storing medical data on medical images, examination results, etc., which are retained by plural medical facilities, in a data center. Furthermore, the present invention relates to a client terminal which is provided in the medical facilities, and a data base server and an application server which are provided in the data center.

2. Description of a Related Art

Conventionally, in a medical facilities such as clinics of general practitioners and hospitals, medical images have been taken using a medical image taking apparatus utilizing radiation (X-ray, α-ray, β-ray, γ-ray, electron beam, ultraviolet light, etc.), ultrasonic wave, MR (magnetic resonance), or the like. Further, various examination results have been obtained by blood examination, electrocardiography, or the like. Such medical information as medical images and examination results are required to be stored in order to know changes in medical conditions of patients, and required to be stored in a predetermined period by law. Accordingly, in the medical facilities, it is necessary to store a vast amount of medical information. Conventionally, films on which medical images are taken, forms filled with examination results, or the like have been stored, and thereby, securing of storage space, management work and retrieval work have imposed heavy burdens on the medical facilities.

Recent years, digitization of medical image taking apparatuses and examination apparatuses has been proceeding, and thereby it is possible to reduce the storage space and save the management work and the retrieval work by recording the medical images and the examination results as medical data in optical disks, magnetic disks, or the like. However, for example, since one sheet of medical image is represented by a vast amount of image data, even if they are recorded in optical disks, a considerable number of optical disks are required to store the medical data in a predetermined period.

In order to such a problem, JP-A-11-45304 discloses a medical support system by which various kinds of medical institutions and their patients can mutually utilize data on medical care and entire medical services can be dramatically improved. In this medical support system, at least medical data of patients created in various medical institutions are centrally managed in a data management institution via a wide area network, and medical services utilizing networks can be provided to various kinds of mutually independent medical institutions and patients by providing the medical data in response to requests from various kinds medical institutions and patients. Thereby, mutual utilization of data on medical care makes group practice and medical data analysis, for example, easier to be performed.

Here, predetermined attribute information is provided to medical data which is centrally managed in the data management institution, and the medical data is managed to be stored and provided using this attribute information. For example, medical data which is centrally managed in the data management institution has plural-layer structure, and provided with attribute information including update dates with respect to each updating of data recorded in different layers. Another recording is inhibited to the layers having the same attribute, and layers having partly the same attribute are correlated and provided. However, JP-A-11-45304 does not disclose measures to distinguish to which medical institution the medical data belongs.

Further, JP-A-2002-24388 discloses an information archive system capable of centrally managing digital data which have been separately managed by independent users. In this information archive system, data files sent to the information archive are divided into hierarchies with respect to each hospital and patient to be stored in a database. However, when the data files are thus divided into hierarchies to be stored in a database, there are problems that the hierarchy structure becomes complicated and management and retrieval of data files become cumbersome.

### SUMMARY OF THE INVENTION

Accordingly, in view of the above-described points, an object of the present invention is to provide a medical data storing method by which management and retrieval can be performed easily without complicating the hierarchy structure of medical data when the medical data on medical images, examination results, or the like retained by plural medical facilities are centrally stored in a data center. Furthermore, another object of the present invention is to provide a client terminal, a data base server, and an application server used in such a medical data storing method.

In order to solve the above-described problems, a medical data storing method according to a first aspect of the present invention is a medical data storing method used in a medical data storage system formed by connecting a client terminal provided in a medical facility, and a database server provided in a data center, via a network, the method comprising the steps of: creating, in the client terminal, third identification information by coupling patient identification information and medical facility identification information which correspond to medical data, in order to store the medical data obtained by imaging or examination for the purpose of diagnosis; transmitting the medical data with at least the third identification information from the client terminal to the database server; and recording, in the database server, the received medical data and at least the received third identification information in association with each other in a recording medium.

A method of storing medical data according to a second aspect of the present invention is a medical data storing method used in a medical data storage system formed by connecting a client terminal provided in a medical facility, and a database server provided in a data center, via a network, the method comprising the steps of: transmitting medical data with patient identification information and medical facility identification information which correspond to the medical data, from the client terminal to the database server in order to store the medical data obtained by imaging or examination for the purpose of diagnosis; creating, in the database server, third identification information by coupling the received patient identification information and the received medical facility identification information; and recording, in the database server, the received medical data and at least the third identification information in association with each other in a recording medium.

A method of storing medical data according to a third aspect of the present invention is a medical data storing method used in a medical data storage system formed by connecting a client terminal provided in a medical facility, and a database server and an application server which are provided in a data center, via a network, the method comprising the steps of: transmitting medical data with patient identification information and medical facility identification information which correspond to the medical data, from the client terminal to the application server in order to store the medical data obtained by imaging or examination for the purpose of diagnosis; creating, in the application server, third identification information by coupling the received patient identification information and the received medical facility identification information; and recording, in the database server, the medical data and at least the third identification information received from the application server, in association with each other in a recording medium.

A client terminal according to a first aspect of the present invention is a client terminal provided in a medical facility and connected to a database server provided in a data center of a medical data storage system, via a network, the client terminal comprising: identification information creating means for creating third identification information by coupling patient identification information and medical facility identification information which correspond to medical data obtained by imaging or examination for the purpose of diagnosis; transmission control means for transmitting the medical data with at least the third identification information created by the identification information creating means, to the database server when the medical data is stored, and transmitting the third identification information created by the identification information creating means, to the database server when the medical data is retrieved.

A database server according to a second aspect of the present invention is a database server provided in a data center of a medical data storage system and connected to a client terminal provided in a medical facility, via a network, the database server comprising: reception control means for receiving medical data obtained by imaging or examination for the purpose of diagnosis, with patient identification information and medical facility identification information which correspond to the medical data, from the client terminal when the medical data is stored, and receiving the patient identification information and the medical facility identification information as a target of retrieval from the client terminal when the medical data is retrieved; identification information creating means for creating third identification information by coupling the patient identification information and the medical facility identification information which are received by the reception control means; medical data management means for recording the medical data received by the reception control means, and at least the third identification information created by the identification information creating means, in association with each other in a recording medium; and retrieving means for retrieving the medical data corresponding to the third identification information created by the identification information creating means, from medical data recorded in the recording medium.

An application server according to a third aspect of the present invention is an application server provided with a database server in a data center of a medical data storage system and connected to a client terminal provided in a medical facility, via a network, the application server comprising: reception control means for receiving medical data obtained by imaging or examination for the purpose of diagnosis, with patient identification information and medical facility identification information which correspond to each other, from the client terminal when the medical data is stored, and receiving the patient identification information and the medical facility identification information as a target of retrieval from the client terminal when the medical data is retrieved; identification information creating means for creating third identification information by coupling the patient identification information and the medical facility identification information which are received by the reception control means; transfer control means for transferring the medical data received by the reception control means, with at least the third identification information created by the identification information creating means, to the database server when the medical data is stored, and transferring the third identification information created by the identification information creating means, to the database server when the medical data is retrieved.

According to the present invention, the third identification information is created by coupling the patient identification information and the medical facility identification information which correspond to the medical data obtained by imaging or examination for diagnostic purposes, and thereby, management and retrieval can be performed easily without complicating the hierarchy structure of the medical data.

### BRIEF DESCRIPTION OF THE DRAWINGS

FIG. 1 is a schematic diagram showing an embodiment of a medical data storage system including a client terminal and a server according to the present invention;

FIG. 2 is a block diagram showing the constitution including a radiation image taking apparatus used in the embodiment of the present invention;

FIG. 3 is a block diagram showing the constitution of the client terminal according to the first embodiment of the present invention;

FIG. 4 shows an example of unique identification information formed by coupling patient identification information and medical facility identification information;

FIG. 5 is a flowchart showing the operation of the medical data storage system when medical data is stored in the first embodiment of the present invention;

FIG. 6 is a flowchart showing the operation of the medical data storage system when medical data is retrieved in the first embodiment of the present invention;

FIG. 7 is a block diagram showing the constitution of a database server according to the second embodiment of the present invention;

FIG. 8 is a flowchart showing the operation of the medical data storage system when medical data is stored in the second embodiment of the present invention;

FIG. 9 is a flowchart showing the operation of the medical data storage system when medical data is retrieved in the second embodiment of the present invention; and

FIG. 10 is a block diagram showing the constitution of an application server according to a modified example of the second embodiment of the present invention.

### DESCRIPTION OF THE PREFERRED EMBODIMENTS

Hereinafter, preferred embodiments of the present invention will be described in detail by referring to the drawings. The same component elements are assigned with the same reference numerals, and the description thereof will be omitted.

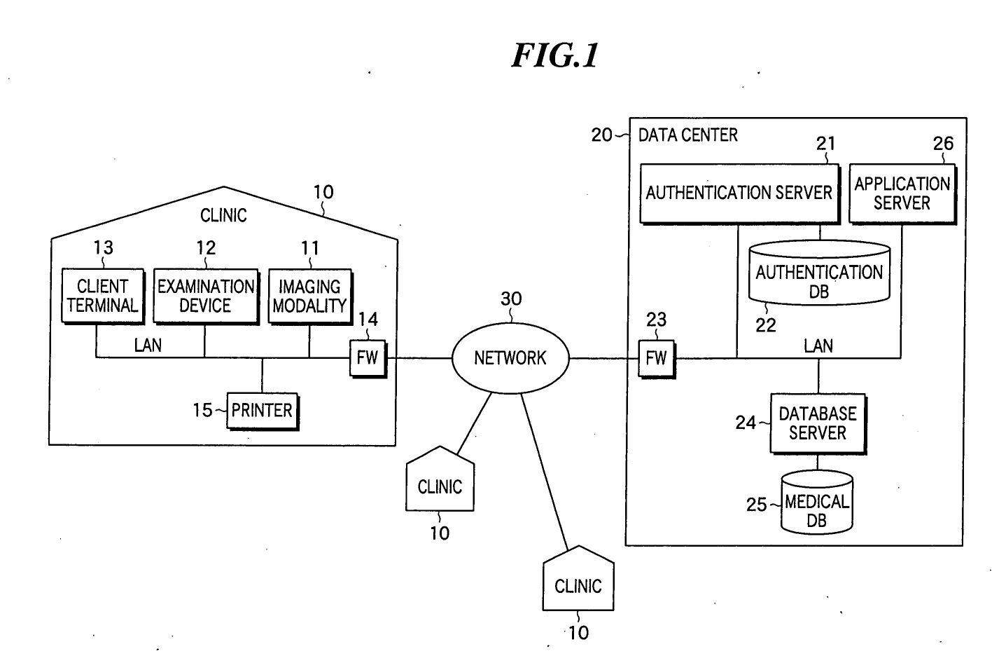

FIG. 1 is a schematic diagram showing an embodiment of a medical data storage system including a client terminal and a server according to the present invention. As shown in FIG. 1, this medical data storage system includes plural clinics 10 as examples of medical facilities which are connected via a network 30 such as a dedicated line, a public switched telephone network (PSTN), the Internet, or the like to a data center 20.

In the respective clinics 10, various kinds of imaging modalities 11 such as radiation image taking apparatuses or ultrasonic diagnostic apparatuses, various examination apparatuses 12 such as electrocardiography apparatuses, client terminals 13 to which various kinds of medical data such as image data representing medical images and examination data representing examination results are inputted from the imaging modalities 11, examination devices 12, or the like to transfer the medical data to the data center 20, firewalls (FW) 14 for preventing unauthorized access, printers 15 for printing out medical images on films or the like, etc. are connected via local area networks (LANs) to one another.

In the data center 20, an authentication server 21 for authenticating access from the client terminal 13, an authentication database (DB) 22 for recording user information required for authentication, a firewall (FW) 23 for preventing unauthorized access, a database server 24 for managing medical data transmitted from the client terminal 13, and a recording medium such as a hard disk in which medical database (DB) 25 for accumulating medical data is recorded are provided. In the embodiment, the authentication server 21 is provided within the data center 20, however, the authentication server 21 may be provided outside of the data center 20. Further, in the data center 20, an application server 26 for receiving data transmitted from the client terminal 13 in place of the database server 24 and processing the received data may be provided.

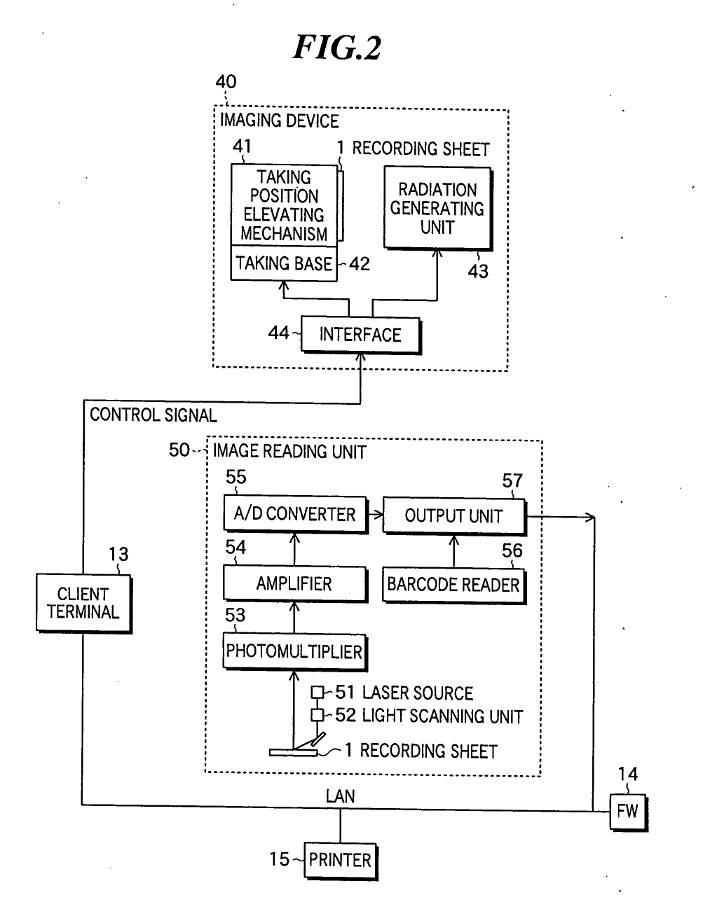

The case of using a radiation image taking apparatus as the imaging modality 11 to generate image data as medical data will be described by referring to FIG. 2. In FIG. 2, the radiation image taking apparatus includes an imaging device 40 for recording a radiation image on a recording sheet 1 by performing imaging by applying radiation on an examinee, and an image reading device 50 for photoelectrically reading information such as the radiation image recorded on the recording sheet 1 and generating image data and image-associated information associated with the radiological image. The recording sheet 1 is coated with a photostimulable phosphor material, and information on a subject is recorded thereon by applying radiation thereto. The photostimulable phosphor material (accumulative phosphor) is a material in which, when applied with radiation, part of radiation energy is accumulated, and then, when applied with excitation light such as visible light, photostimulably emits light according to the accumulated energy.

The imaging device 40 includes a taking position elevating mechanism 41 for elevating the taking position in the examinee by finely adjusting the position of the recording sheet 1 set in a predetermined position to move upward or downward, a taking base 42 for positioning the feet of the examinee, a radiation generating unit 43 for applying radiation to the examinee, and an interface 44 to which a control signal is inputted from the client terminal 13.

The image reading device 50 scans the surface of the recording sheet 1 set in a predetermined position with a light beam which is outputted from the laser source 51 to pass through the light scanning unit 52. By the scanning, the light beam is applied to the recording sheet 1, and photostimulably emitted light is generated in an amount of light depending on the radiation image information which has been accumulatively recorded from the location applied with the light beam. The photostimulably emitted light is photoelectrically detected by a photomultiplier 53, outputted as analog signals, amplified by an amplifier 54, and digitized by an A/D converter 55. Further, a barcode attached to a cassette in which the recording sheet 1 is stored is read by a barcode reader 56, and the read barcode information is used as image-associated information corresponding to patient information and examination information. Thus generated image data and image-associated information are transmitted from an output unit 57 via a LAN to the client terminal 13.

The client terminal 13 controls the imaging device 40, and receives the image data and the image-associated information from the image reading device 50 to temporarily store them. In the client terminal 13, image processing can be performed on the image data, or images for diagnosis can be displayed based on the image data and the image-associated information on a display or the like. Note that, because vast amounts of image data are daily accumulated, they are stored not for a long period in the clinic, but transferred to a data center apart from the clinic and stored there. Thereby, in the clinic, the space for storing recording media in which medical data have been recorded, or the costs for securing the space can be reduced.

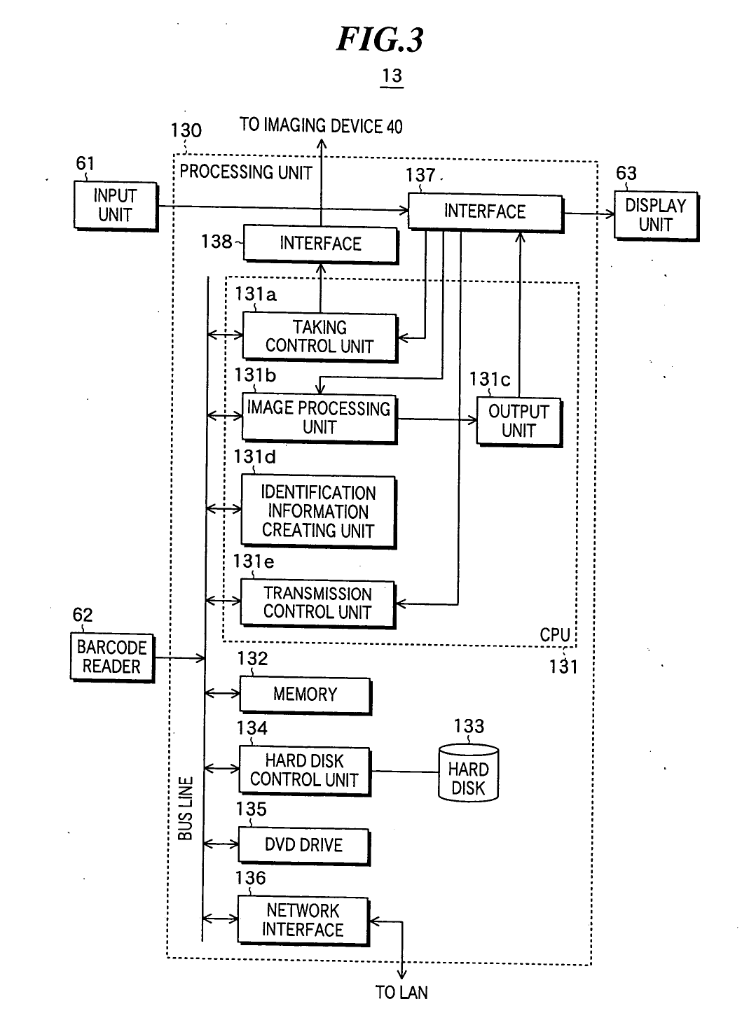

FIG. 3 is a block diagram showing the constitution of the client terminal according to the first embodiment of the present invention. The client terminal 13 includes an input unit 61 used for inputting patient information and various kinds of commands or the like, a barcode reader 62 for reading a barcode attached to a cassette in which the recording sheet 1 is stored, a display unit 63 for displaying images for diagnosis or the like, and a processing unit 130. The medical images read by the image reading device 50 (FIG. 2) are correlated with the patient information and the examination information which are stored in the client terminal 13, based on the barcode information read from the cassette using the barcode reader 62 in advance before taking.

The processing unit 130 includes a central processing unit (hereinafter, referred to as CPU) 131, a memory 132 for temporarily storing the inputted image data and image-associated information, a hard disk 133, a hard disk control unit 134 for controlling writing and reading of data in the hard disk 133, a DVD drive 135 for performing writing and reading of data on a DVD (digital versatile disk), and a network interface 136 for connection to a LAN. These parts 131 to 136 are connected to one another via a bus line.

Furthermore, the processing unit 130 includes interfaces 137 and 138. The CPU 131 is connected to the input unit 61 such as a keyboard or mouse and the display unit 63 such as a CRT display via the interface 137, and connected to the imaging device 40 via the interface 138.

The memory 132 temporarily stores the medical data received from the imaging modality, the examination device, or the like. In the hard disk 133, software (program) for allowing the CPU 131 to perform operation is recorded. As the recording medium for recording the program, not only the built-in hard disk 133 or a DVD-ROM inserted into the DVD drive 135, but also an external hard disk, a flexible disk, an MO, an MT, a RAM, a CD-ROM, or the like may be used.

Next, function blocks 131a to 131e formed by the CPU 131 and the software (program) will be described.

The taking control unit 131a controls taking in the imaging device 40. The image processing unit 131b performs necessary image processing on the image data received from the image reading device. The image data subjected to the necessary image processing is supplied from the output unit 131c via the interface 137 to the display unit 63, images are displayed on the display unit 63, and the images are confirmed by an operator. Further, the image data subjected to the necessary image processing is stored in the memory 132 and recorded in the hard disk 133 by the hard disk control unit 134 according to the set conditions.

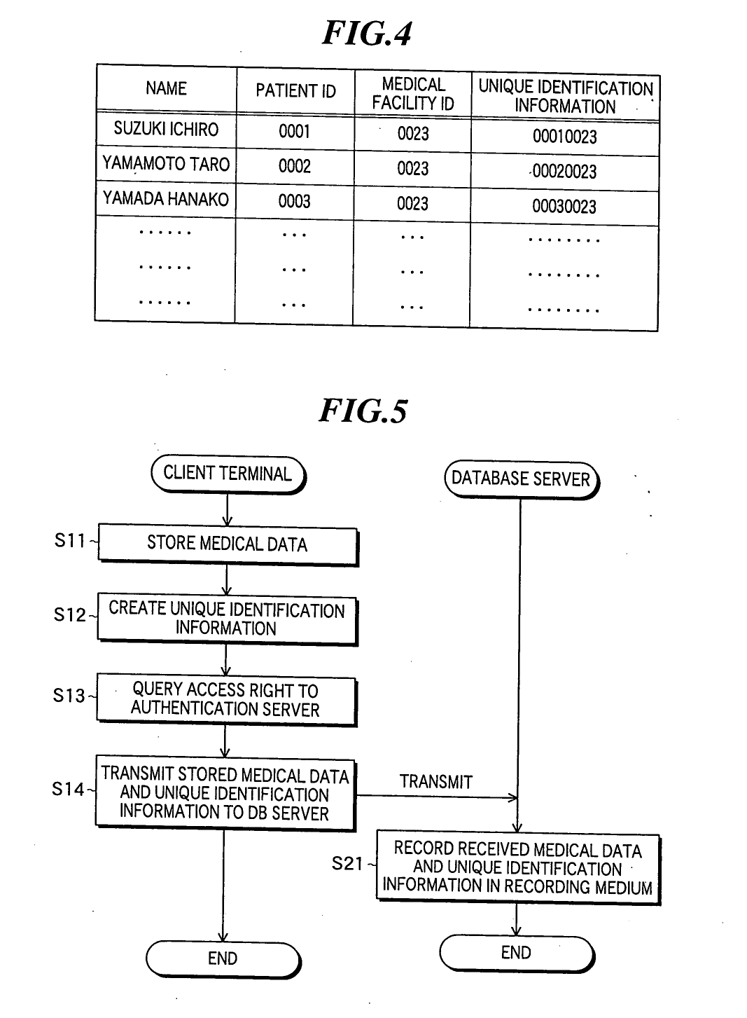

When the medical data is thus generated, in order to store the medical data in the data center, the identification information creating unit 131d creates unique identification information by coupling the patient identification information (patient ID) included in patient information corresponding to the medical data, and medical facility identification information (medical facility ID) attached to the respective medical facilities for identifying the medical facilities, as shown in FIG. 4, for example. Here, the unique identification information is information such as numbers or signs which can uniquely identify both the patient and the medical facility for preventing confusion between patients in the case where the medical data of patients are stored with respect to the plural medical facilities.

In the example shown in FIG. 4, with respect to patient name “Suzuki Ichiro”, patient ID code “0001” and medical facility ID code “0023” are coupled to create unique identification information “00010023”. Further, with respect to patient name “Yamamoto Taro”, patient ID code “0002” and medical facility ID code “0023” are coupled to create unique identification information “00020023”. Similarly, with respect to patient name “Yamada Hanako”, patient ID code “0003” and medical facility ID code “0023” are coupled to create unique identification information “00030023”.

According to the instruction using the input unit 61 by the operator or the set conditions, the transmission control unit 131e starts to access the data center 20. When the medical data stored in the data center 20 is retrieved in the clinic, the transmission control unit 131e also accesses the data center 20.

In the data center 20, in order to prevent leaks of personal information, falsification of medical image data, or the like, an authentication is requested to access to the medical image data, and access to the medical image data is inhibited until it is allowed by the authentication. When the transmission control unit 131e makes inquiries about access right to the authentication server 21 (FIG. 1) of the data center 20, the authentication server 21 starts authentication.

After the access right is authenticated, when the medical data is stored, the transmission control unit 131e transmits the medical data which is stored in storage means such as the memory 132 or the hard disk 133 shown in FIG. 3, and at least the unique identification information which is created by the identification information creating unit 131d, to the database server 24 (FIG. 1) of the data center 20, and allows the recording of them in the medical database (DB) 25. Further, when the medical data is retrieved, the transmission control unit 131e transmits the unique identification information which is created by the identification information creating unit 131d, to the database server 24 of the data center 20, and allows the retrieval in the medical database (DB) 25. Thus, by storing the medical data in the data center 20 in association with the unique identification information, the management and the retrieval can be performed easily without complicating the hierarchy structure of the medical data.

By the way, in the embodiment, the taking control unit 131a, the image processing unit 131b, the output unit 131c, the identification information creating unit 131d, and the transmission control unit 131e are formed by the CPU and the software, however, they may be formed by digital circuits or analog circuits.

Next, the operation of the medical data storage system including the client terminals according to the embodiment will be described by referring to FIGS. 1, 5, and 6.

FIG. 5 is a flowchart showing the operation of the medical data storage system when medical data is stored.

At step S11, the client terminal 13 of the clinic 10 inputs medical data from the imaging modality 11 or the examination device 12, and stores the medical data in storage means such as a memory or a hard disk. Then, at step S12, the client terminal 13 creates unique identification information by coupling patient identification information included in patient information corresponding to the medical data, and medical facility identification information attached to the respective medical facilities for identifying the medical facilities.

At step S13, the client terminal 13 queries the access right to the authentication server 21 of the data center 20. After the access right is authenticated, the process moves to step S14, and the client terminal 13 transmits the stored medical data with at least the unique identification information to the database server 24 of the data center 20.

At step S21, the database server 24 of the data center 20 records the received medical data with at least the unique identification information to the recording medium such as a hard disk in which the medical data base 25 has been recorded.

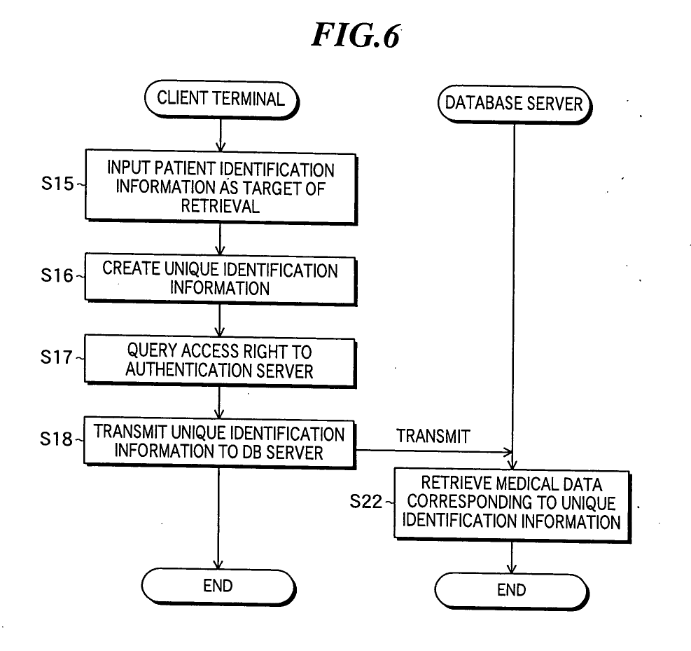

FIG. 6 is a flowchart showing the operation of the medical data storage system when medical data is retrieved.

At step S15, the operator inputs patient identification information as a target of retrieval by the operation of the input unit 61 of the client terminal 13 or the like. Then, at step S16, the client terminal 13 creates unique identification information by coupling the inputted patient identification information and the medical facility identification information attached to the respective medical facilities for identifying the medical facilities.

At step S17, the client terminal 13 queries the access right to the authentication server 21 of the data center 20. After the access right is authenticated, the process moves to step S18, and the client terminal 13 transmits the unique identification information to the database server 24 of the data center 20.

At step S22, the database server 24 of the data center 20 retrieves the medical data corresponding to the received unique identification information, from medical data which have been recoded in the recording medium of the medical database 25.

Next, the second embodiment of the present invention will be described. In the second embodiment, in the medical data storage system shown in FIG. 1, the database server 24 of the data center 20 performs the creation of the unique identification information, and other points are the same as in the first embodiment.

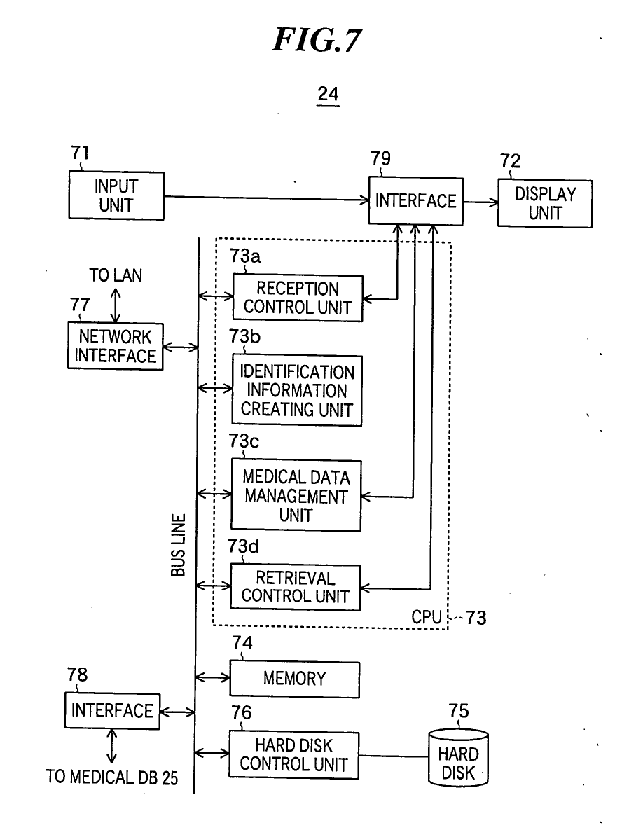

FIG. 7 is a block diagram showing the constitution of a database server according to the second embodiment of the present invention. The database server 24 includes an input unit 71 used for inputting various kinds of commands, a display unit 72 for display for management of medical data, a central processing unit (hereinafter, referred to as CPU) 73 to which the input unit 71 and the display unit 72 are connected via an interface 79, a memory 74 for temporarily storing medical data received from the client terminal 13, a hard disk 75, a hard disk control unit 76 for controlling writing and reading of data in the hard disk 75, a network interface 77 for connection to a LAN, and an interface 78 for controlling a hard disk or the like in which the medical database (DB) 25 has been recorded. These parts 73 to 78 are connected to one another via a bus line.

The memory 74 temporarily stores the medical data received from the client terminal 13. In the hard disk 75, software (program) for allowing the CPU 73 to perform operation is recorded. As the recording medium for recording the program, not only the built-in hard disk 75, but also an external hard disk, a flexible disk, an MO, an MT, a RAM, a CD-ROM, a DVD-ROM, or the like may be used.

Next, function blocks. 73a to 73d formed by the CPU 73 and the software (program) will be described.

When the medical data is stored, the reception control unit 73a receives medical data which is obtained by the imaging or the examination for the purpose of diagnosis, and patient information including patient identification information corresponding to this medical data, and medical facility identification information attached to the respective medical facilities for identifying the medical facilities, from the client terminal 13.

The identification information creating unit 73b creates unique identification information by coupling the patient identification information and the medical facility identification information which are received by the reception control unit 73a. The medical data management unit 73c correlates the medical data which is received by the reception control unit 73a, and the unique identification information which is created by at least the identification information creating unit 73b, and then records them in the recording medium of the medical database 25.

Here, it is desired that the medical data management unit 73c records the medical data and the unique identification information with medical facility identification information of the consultation facility to which access control information for controlling access to the medical data has been attached, in the recording medium of the medical database 25.

When the medical data is retrieved, the reception control unit 73a receives the patient identification information and the medical facility identification information as a target of retrieval from the client terminal 13. The identification information creating unit 73b creates unique identification information by coupling the patient identification information and the medical facility identification information which are received by the reception control unit 73a. The retrieval control unit 73d retrieves the medical data corresponding to the unique identification information which is created by the identification information creating unit 73b, from the medical data which have been recorded in the recording medium of the medical database 25.

Since the medical data is stored in the data center 20 in association with the unique identification information, only the client who has transmitted the medical data can perform the retrieval without complicating the hierarchy structure of the medical data. Further, in the case where the access control information is added and stored with the medical data and the unique identification information, other medical facilities corresponding to the medical facility identification information which has been allowed to access the medical data can also access the medical data.

In the above description, when the medical data is stored, the information on the attributes of patients (patient attribute information) has been transmitted from the client terminal 13 to the data center 20, this patient attribute information has been recorded in the patient information database or the like within the data center 20, and the identification information creating unit 73b queries Basic Resident Registers network based on the recorded patient attribute information, and thereby, the acquisition of the corresponding Basic Resident Registers number may be tried. When the Basic Resident Registers number is acquired successfully, the identification information creating unit 73b correlates the Basic Resident Registers number and the patient identification information, and stores them in a table in the patient information database or the like. Further, the medical data management unit 73c records the medical data and the unique identification information with the above-described Basic Resident Registers number in association with these in the recording medium of the medical database 25.

When the medical data is retrieved, the patient identification information of the patient and the medical facility identification information as a target of retrieval are transmitted from the client terminal 13 to the database server 24. The identification information creating unit 73b of the database server 24 refers to the above-described table based on the patient identification information as a target of retrieval, and thereby, reads out the corresponding Basic Resident Registers number. The retrieval control unit 73d retrieves the medical data corresponding to the above-described Basic Resident Registers number from the medical data which have been recorded in the recording medium of the medical data base 25. In the case where the same patient has been examined in plural medical facilities, even when different medical facility identification information is attached to the medical data of the same patient, by retrieving the medical data based on the Basic Resident Registers number used commonly over the entire country, the medical data transmitted from all of the medical facilities can be retrieved.

Especially, with respect to the medical data of the patient introduced by the first consultation facility to the second consultation facility, when the medical data transmitted from the first consultation facility is stored, access control information representing the fact that access is allowed in association with the medical facility identification information of the second consultation facility, and thereby, the Basic Resident Registers number of the patient is correlated with the patient identification information to be available. The authentication server 21 performs the determination as to there is an access right or not based on the access control information.

Alternatively, in place of the Basic Resident Registers number, the authentication by biometrics may be used. The authentication by biometrics refers to confirmation as to the identity using a fingerprint, a facial form, a hand form, an iris, or the like unique to each person for the purpose of entering and leaving a facility which attaches importance on security, log-in to an information system, or the like.

That is, when the medical data is stored, the identification information creating unit 73b of the database server 24 correlates the living body information on at least one of a fingerprint, a facial form, a hand form, an iris of a patient, and the patient identification information based on the patient attribute information transmitted from the client terminal 13, and then stores them in a table, and records the above-described living body information in association with the medical data received by the reception control unit 73a, in the recording medium of the medical database 25.

When the medical data is retrieved, the patient identification information of the patient and the medical facility identification information as a target of retrieval are transmitted from the client terminals 13 to the database server 24. The identification information creating unit 73b of the database server 24 refers to the above-described table based on the patient identification information as a target of retrieval, and thereby, reads out the corresponding living body information. The retrieval control unit 73d retrieves the medical data corresponding to the above-described living body information, from the medical data which have been recorded in the recording medium of the medical database 25.

By the way, in the embodiment, the reception control unit 73a, the identification information creating unit 73b, the medical data management unit 73c, and the retrieval control unit 73d are formed by the CPU and the software, however, they may be formed by digital circuits or analog circuits.

Next, the operation of the medical data storage system including the database server according to the embodiment will be described by referring to FIGS. 1, 8, and 9.

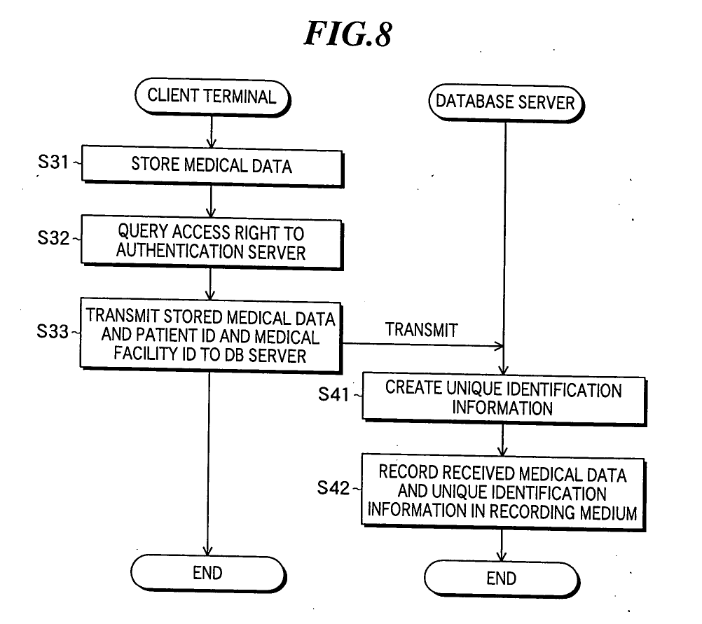

FIG. 8 is a flowchart showing the operation of the medical data storage system when medical data is stored.

At step S31, the client terminal 13 of the clinic 10 inputs medical data from the imaging modality 11 or the examination device 12, and stores the medical data in storage means such as a memory or a hard disk. Then, at step S32, the client terminal 13 queries the access right to the authentication server 21 of the data center 20. After the access right is authenticated, the process moves to step S33, and the client terminal 13 transmits the stored medical data with patient identification information which is included in patient information corresponding to the medical data, and medical facility identification information which is attached to the respective medical facilities for identifying the medical facilities, to the database server 24 of the data center 20.

At step S41, the database server 24 of the data center 20 creates unique identification information by coupling the patient identification information and the medical facility identification information. At step S42, the database server 24 records the received medical data with at least the unique identification information in the recording medium of the medical database 25.

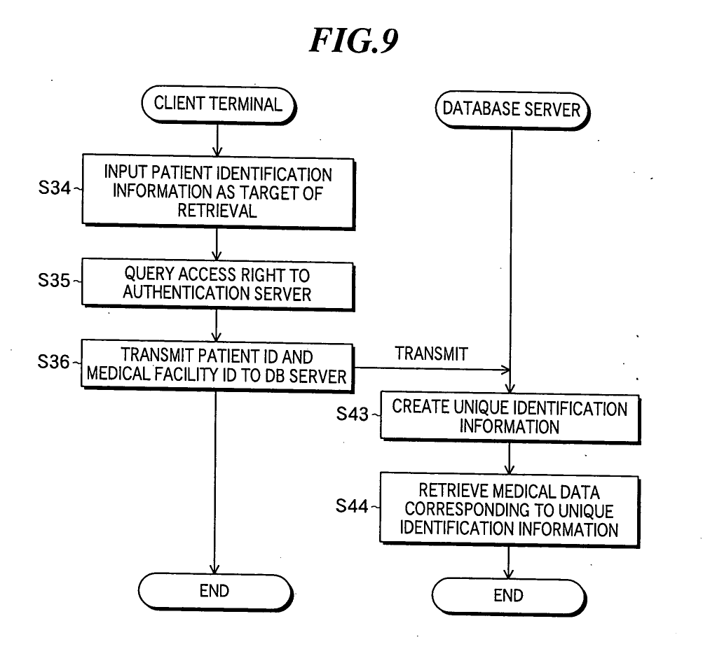

FIG. 9 is a flowchart showing the operation of the medical data storage system when medical data is retrieved.

At step S34, the operator inputs patient identification information as a target of retrieval by the operation of the input unit 61 of the client terminal 13 or the like. Then, at step S35, the client terminal 13 queries the access right to the authentication server 21 of the data center 20. After the access right is authenticated, the process moves to step S36, and the client terminals 13 transmits the stored medical data with at least the unique identification information from the client terminal 13 to the database server 24 of the data center 20.

At step S43, the database server 24 creates unique identification information by coupling the received patient identification information and the received medical facility identification information. At step S44, the database server 24 retrieves the medical data corresponding to the created unique identification information, from medical data recorded in the recording medium of the medical database 25.

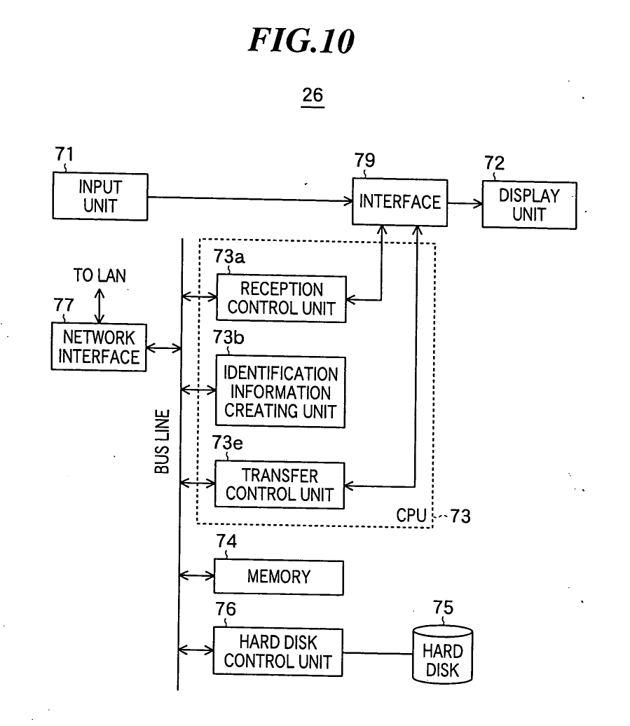

Next, a modified example of the second embodiment of the present invention will be described. In the second embodiment of the present invention, the application server 26 shown in FIG. 10 may have the functions of the reception control unit 73a and the identification information creating unit 73b shown in FIG. 7. The application server 26 is further provided with the transfer control unit 73e as a function block.

In this case, when the reception control unit 73a of the application server 26 shown in FIG. 10 stores medical data, the reception control unit 73a receives the medical data with patient identification information and medical facility identification information which correspond to the medical data, from the client terminals 13. When the reception control unit 73a retrieves the medical data, the reception control unit 73a receives the patient identification information and the medical facility identification information as a target of retrieval from the client terminal 13. The identification information creating unit 73b creates unique identification information by coupling the patient identification information and the medical facility identification information which are received by the reception control unit 73a.

When the medical data is stored, the transfer control unit 73e transfers the medical data, which is received by the reception control unit 73a, with at least the unique identification information, which is created by the identification information creating unit 73b, to the database server 24. When the medical data is retrieved, the transfer control unit 73e transfers the unique identification information created by the identification information creating unit 73b, to the database server 24.

In the database server 24, when the medical data is stored, the medical data management unit 73c correlates the medical data transferred from the application server 26, and the unique identification information, and records them in the recording medium of the medical database 25. Here, the patient identification information and the medical facility identification information may not be recorded in the recording medium of the medical database 25.

When the medical data is retrieved, the application server 26 separates the unique identification information read from the medical database 25, and thereby, can transmit the patient identification information and the medical facility identification information separately to the client terminals 13. Further, the retrieval control unit 73d of the database server 24 retrieves the medical data recorded in the medical database 25, based on the unique identification information transferred from the application server 26.

1. A medical data storing method used in a medical data storage system formed by connecting a client terminal provided in a medical facility, and a database server provided in a data center, via a network, said method comprising the steps of:
creating, in said client terminal, third identification information by coupling patient identification information and medical facility identification information which correspond to medical data, in order to store the medical data obtained by imaging or examination for the purpose of diagnosis;
transmitting the medical data with at least the third identification information from said client terminal to said database server; and
recording, in said database server, the received medical data and at least the received third identification information in association with each other in a recording medium.

2. The medical data storing method according to claim 1, further comprising the steps of:
creating, in said client terminal, the third identification information by coupling the patient identification information and the medical facility identification information as a target of retrieval in order to retrieve the medical data;
transmitting the third identification information from said client terminal to said database server; and
retrieving, in said database server, the medical data corresponding to the third identification information, from medical data recorded in said recording medium.

3. A medical data storing method used in a medical data storage system formed by connecting a client terminal provided in a medical facility, and a database server provided in a data center, via a network, said method comprising the steps of:
transmitting medical data with patient identification information and medical facility identification information which correspond to the medical data, from said client terminal to said database server in order to store the medical data obtained by imaging or examination for the purpose of diagnosis;
creating, in said database server, third identification information by coupling the received patient identification information and the received medical facility identification information; and
recording, in said database server, the received medical data and at least the third identification information in association with each other in a recording medium.

4. The medical data storing method according to claim 3, further comprising the steps of:
transmitting the patient identification information and the medical facility identification information as a target of retrieval from said client terminals to said database server in order to retrieve the medical data;
creating, in said database server, the third identification information by coupling the received patient identification information and the received medical facility identification information; and
retrieving the medical data corresponding to the third identification information, from medical data recorded in said recording medium.

5. A medical data storing method used in a medical data storage system formed by connecting a client terminal provided in a medical facility, and a database server and an application server which are provided in a data center, via a network, said method comprising the steps of:
transmitting medical data with patient identification information and medical facility identification information which correspond to the medical data, from said client terminal to said application server in order to store the medical data obtained by imaging or examination for the purpose of diagnosis;
creating, in said application server, third identification information by coupling the received patient identification information and the received medical facility identification information; and
recording, in said database server, the medical data and at least the third identification information which are received from said application server, in association with each other in a recording medium.

6. The medical data storing method according to claim 5, further comprising the steps of:
transmitting the patient identification information and the medical facility identification information as a target of retrieval from said client terminals to said application server in order to retrieve the medical data;
creating, in said application server, the third identification information by coupling the received patient identification information and the received medical facility identification information; and
retrieving, in said database server, the medical data corresponding to the third identification information, from medical data recorded in said recording medium.

7. The medical data storing method according to claim 1, further comprising the steps of:
trying, in said database server or said application server, to acquire a corresponding Basic Resident Registers number by querying Basic Resident Registers network based on information on a patient attribute transmitted from said client terminal, in order to store medical data;
storing, when the Basic Resident Registers number is successfully acquired, in said database server the Basic Resident Registers number and the patient identification information in association with each other in a table, and recording the Basic Resident Registers number in association with the medical data received by said database server or said application server, in said recording medium.

8. The medical data storing method according to claim 7, further comprising the steps of:
transmitting the patient identification information and the medical facility identification information on a patient who is a target of retrieval, from said client terminal to said database server or said application server in order to retrieve the medical data;
reading out, in said database server or said application server, the corresponding Basic Resident Registers number by referring to said table based on the patient identification information of the patient who is the target of retrieval; and
retrieving, in said database server, the medical data corresponding to the Basic Resident Registers number, from medical data recorded in said recording medium.

9. The medical data storing method according to claim 8, wherein access control information for controlling access to the medical data is added to the medical data and stored in association with the medical facility identification information of a consultation facility to be requested for retrieval, when the medical data transmitted from a first consultation facility is stored, with respect to a patient introduced from the first consultation facility to a second consultation facility, access control information representing that access is allowed is added in association with the medical facility identification information of the second consultation facility, and the Basic Resident Registers number of the patient is correlated with the patient identification information to be available.

10. The medical data storing method according to claim 3, further comprising the steps of:
trying, in said database server or said application server, to acquire a corresponding Basic Resident Registers number by querying Basic Resident Registers network based on information on a patient attribute transmitted from said client terminal, in order to store medical data;
storing, when the Basic Resident Registers number is successfully acquired, in said database server the Basic Resident Registers number and the patient identification information in association with each other in a table, and recording the Basic Resident Registers number in association with the medical data received by said database server or said application server, in said recording medium.

11. The medical data storing method according to claim 10, further comprising the steps of:
transmitting the patient identification information and the medical facility identification information on a patient who is a target of retrieval, from said client terminal to said database server or said application server in order to retrieve the medical data;
reading out, in said database server or said application server, the corresponding Basic Resident Registers number by referring to said table based on the patient identification information of the patient who is the target of retrieval; and
retrieving, in said database server, the medical data corresponding to the Basic Resident Registers number, from medical data recorded in said recording medium.

12. The medical data storing method according to claim 10, wherein access control information for controlling access to the medical data is added to the medical data and stored in association with the medical facility identification information of a consultation facility to be requested for retrieval, when the medical data transmitted from a first consultation facility is stored, with respect to a patient introduced from the first consultation facility to a second consultation facility, access control information representing that access is allowed is added in association with the medical facility identification information of the second consultation facility, and the Basic Resident Registers number of the patient is correlated with the patient identification information to be available.

13. The medical data storing method according to claim 5, further comprising the steps of:
trying, in said database server or said application server, to acquire a corresponding Basic Resident Registers number by querying Basic Resident Registers network based on information on a patient attribute transmitted from said client terminal, in order to store medical data;
storing, when the Basic Resident Registers number is successfully acquired, in said database server the Basic Resident Registers number and the patient identification information in association with each other in a table, and recording the Basic Resident Registers number in association with the medical data received by said database server or said application server, in said recording medium.

14. The medical data storing method according to claim 13, further comprising the steps of:
transmitting the patient identification information and the medical facility identification information on a patient who is a target of retrieval, from said client terminal to said database server or said application server in order to retrieve the medical data;
reading out, in said database server or said application server, the corresponding Basic Resident Registers number by referring to said table based on the patient identification information of the patient who is the target of retrieval; and
retrieving, in said database server, the medical data corresponding to the Basic Resident Registers number, from medical data recorded in said recording medium.

15. The medical data storing method according to claim 13, wherein access control information for controlling access to the medical data is added to the medical data and stored in association with the medical facility identification information of a consultation facility to be requested for retrieval, when the medical data transmitted from a first consultation facility is stored, with respect to a patient introduced from the first consultation facility to a second consultation facility, access control information representing that access is allowed is added in association with the medical facility identification information of the second consultation facility, and the Basic Resident Registers number of the patient is correlated with the patient identification information to be available.

16. The medical data storing method according to claim 1, further comprising the steps of:
storing, in said data base server or said application server, living body information on at least one of a fingerprint, a face form, a hand form, and an iris of a patient, and patient identification information based on information on a patient attribute, which is transmitted from said client terminal, in association with each other in a table in order to store the medical data, and recording the living body information in association with the medical data received by said database server or said application server, in said recording medium.

17. The medical data storing method according to claim 16, further comprising the steps of:
transmitting patient identification information on a patient as a target of retrieval and medical facility identification information from said client terminal to said database server or said application server in order to retrieve the medical data;
reading out, in said database server or said application server, corresponding living body information by referring to said table based on the patient identification information on the patient as the target of retrieval; and
retrieving, in said database server, the medical data corresponding to the living body information from medical data recorded in said recording medium.

18. A client terminal provided in a medical facility and connected to a database server provided in a data center of a medical data storage system, via a network, said client terminal comprising:
identification information creating means for creating third identification information by coupling patient identification information and medical facility identification information which correspond to medical data obtained by imaging or examination for the purpose of diagnosis; and
transmission control means for transmitting the medical data with at least the third identification information created by said identification information creating means, to said database server when the medical data is stored, and transmitting the third identification information created by said identification information creating means, to said database server when the medical data is retrieved.

19. A database server provided in a data center of a medical data storage system and connected to a client terminal provided in a medical facility, via a network, said database server comprising:
reception control means for receiving medical data obtained by imaging or examination for the purpose of diagnosis, with patient identification information and medical facility identification information which correspond to the medical data, from said client terminal when the medical data is stored, and receiving the patient identification information and the medical facility identification information as a target of retrieval from said client terminal when the medical data is retrieved;
identification information creating means for creating third identification information by coupling the patient identification information and the medical facility identification information which are received by said reception control means;
medical data management means for recording the medical data received by said reception control means, and at least the third identification information created by said identification information creating means, in association with each other in a recording medium; and
retrieving means for retrieving the medical data corresponding to the third identification information created by said identification information creating means, from medical data recorded in said recording medium.

20. An application server provided with a database server in a data center of a medical data storage system and connected to a client terminal provided in a medical facility, via a network, said application server comprising:
reception control means for receiving medical data obtained by imaging or examination for the purpose of diagnosis, with patient identification information and medical facility identification information which correspond to each other, from said client terminal when the medical data is stored, and receiving the patient identification information and the medical facility identification information as a target of retrieval from said client terminal when the medical data is retrieved;
identification information creating means for creating third identification information by coupling the patient identification information and the medical facility identification information which are received by said reception control means; and
transfer control means for transferring the medical data received by said reception control means, with at least the third identification information created by said identification information creating means, to said database server when the medical data is stored, and transferring the third identification information created by said identification information creating means, to said database server when the medical data is retrieved.
